(19) United States
(12) Patent Application Publication
(10) Pub. No.: US 2009/0017856 A1
(43) Pub. Date: Jan. 15, 2009

(54) Transfer of Part of a Push to Talk Session

(76) Inventors: Henrik Albertsson, Stockholm (SE); Jan Holm, Orbyhus (SE)

Correspondence Address: ERICSSON INC., 6300 LEGACY DRIVE, M/S EVR 1-C-11, PLANO, TX, 75024, US

(21) Appl. No.: 12/091,220

(22) PCT Filed: Oct. 31, 2005
(86) PCT No.: PCT/EP2005/055671

§ 371 Date: Sep. 17, 2008

(51) Int. Cl. H04B 7/00

(52) U.S. Cl. 455/518

(57) ABSTRACT

A method and apparatus for transferring part of a push to talk type session from a first mobile terminal to a second mobile terminal. The first terminal sends a SIP REFER message to a PoC server controlling the session. The SIP REFER message identifies the second terminal and the part of the session to be transferred. The transferred part may be a media type that is not supported or accepted by the first terminal. The PoC server sends a SIP INVITE message to the second terminal and indicates the part of the session to be transferred. The PoC server may send NOTIFY messages to the first terminal indicating the status of the transfer. If the transfer is accepted, the PoC server may send a confirmation to the first terminal, which may then send a re-INVITE message to the PoC server to remove responsibility for the transferred part of the session.

### BACKGROUND OF THE INVENTION

1. Field of the Invention

The present invention relates to methods and apparatus for use in a push to talk type service, for example a so-called push to talk over cellular service.

2. Description of the Related Art

Walkie-talkie type services have long proved popular amongst users who wish to communicate brief messages quickly between one another. Conventionally, such services have been provided by two-way portable radios which utilise a dedicated part of the radio spectrum, but which only allow users to communicate with a small group of pre-selected users who utilise similar terminals and who are within range of the relatively short operating range of the radios. More recently, services have been introduced into the United States which piggy-back on the existing cellular telephone infrastructure. However, these services have been proprietary in nature and have not allowed users to communicate between different operator networks.

In an attempt to broaden the use of walkie-talkie type services, an industry grouping known as the Open Mobile Alliance (www.openmobilealliance.org) has been established with the aim of standardising suitable protocols which will allow inter-network operability for Walkie-Talkie services offered over cellular networks. The service established by the various standards is known as Push to talk Over cellular (PoC). PoC proposes that associated speech data will be transported over a packet switched access network. In the case of GSM and UMTS, this will be the general packet radio service (GPRS) or 3G access network. In other network architectures, analogous packet switched access networks will be utilised for transporting talk data. Push to Talk services may also be offered over circuit switched access networks, although this is not the preferred option.

The Push to talk over Cellular (PoC) system is typically implemented on GSM/GPRS/3G networks and which makes use of the IP Multimedia Subsystem (IMS) standardised by the 3^{rd} Generation Partnership Project to facilitate the introduction of advanced data services into cellular networks, and in particular of real-time multimedia services. The IMS relies upon the Session Initiation Protocol (SIP) which has been defined by the Internet Engineering Task Force (IETF) for the setting up and control of multimedia IP-based sessions (see IETF RFC 3261 “SIP: Session Initialisation Protocol”, http://www.ietf.org/rfc/rfc3261.txt). A PoC Server is located within the IMS or is attached thereto, and implements the functionality for setting up and controlling PoC Sessions.

Existing push-to-talk (PTT) and conferencing systems typically use a control mechanism to grant one of the users the right to speak while other users in the communication are denied such right and are in listening mode. Such control mechanism is typically referred to as floor control, talker arbitration, talk burst control, etc. For example, the Open Mobile Alliance is currently working on a specification of Push-To-Talk over Cellular (PoC) system, which includes Talk Burst Control Protocol (TBCP).

To request the right to speak on behalf of the user, the terminal (PoC Client) typically sends a request message to the controller (PoC Server). The controller typically responds either granting or rejecting the request. The controller typically restricts the time the user is allowed to talk, typically by starting an allowed talk timer when it grants the request, and uses some mechanism to interrupt the user, typically by sending a revoke message to the user's terminal or by simply not forwarding the user's media. The user who is interrupted by the controller is typically penalised by the controller in some way, e.g. by not granting the user the right to speak for a certain period of time.

The next version of OMA PoC (herein called “PoC 2”, with the previous version being called “PoC 1”) is evolving in OMA [OMA-RD-PoC-V2_{—}0-20050902-D Push to Talk Over Cellular 2 Requirements, Draft Version 2.0-02. September 2005]. Part of the new functionality in PoC 2 is to include new media types, allowing the sending of pictures, video etc in the PoC Sessions. PoC 2 includes a requirement for seamless transfer of video to another PoC Client.

An existing procedure specified by the IETF (Internet Engineering Task Force) enables the transfer of a call to another device. However, this procedure does not include a conference bridge or allow the transfer of only part of a call (e.g. only the video component). Furthermore it is built on another architecture. A solution built on the OMA PoC architecture, including the transfer of only part of the call, does not exist.

It is therefore desirable to provide a method for the seamless transfer a PoC Session or part thereof from one PoC Client to another PoC Client.

### SUMMARY OF THE INVENTION

According to a first aspect of the present invention there is provided a method of transferring at least part of a push to talk type session from a first terminal to a second terminal, comprising using a Session Initiation Protocol, SIP, REFER message indicating which part, or that the whole, of the session is to be transferred.

The method may comprise sending the SIP REFER message from the first terminal to a server designated to control the session, or receiving the SIP REFER message from the first terminal at a server designated to control the session.

The method may comprise, in response to receipt at the server of the SIP REFER message, sending a SIP INVITE message to the second terminal.

The SIP REFER message may comprise information for use in identifying the second terminal.

The SIP REFER message may comprise an address of the second terminal.

The SIP REFER message may comprise a Push to talk over Cellular, PoC, address of the second terminal, such as a SIP URI or a TEL URI.

The SIP REFER message may comprise a Globally Routable User Agent URI, GRUU, address of the second terminal.

The method may comprise including the identifying information in the SIP INVITE message.

The method may comprise receiving the SIP INVITE message at the first terminal in the case where the identifying information identifies the first terminal, and rejecting the invitation in response.

The method may comprise, at least in the case where only part of the session is being transferred, including SDP information in the SIP REFER message to indicate the part to be transferred.

The method may comprise, where the session is ongoing, removing or modifying the SDP information at the server in order to align to the ongoing session.

The method may comprise including the SDP information in the SIP INVITE message.

The method may comprise sending at least one status update message to the first terminal to inform the first terminal of progress of the transfer.

At least one status update message may be a SIP NOTIFY message, such as a “Ringing” or “Trying” message.

The method may comprise indicating a preference to receive such update messages by not including a “norefersub” option-tag in the SIP REFER message.

The method may comprise, in the case where only part of the session is being transferred, performing a procedure at the first terminal to remove responsibility in the session for the transferred part after it is confirmed that responsibility for that part has been accepted by the second terminal.

The procedure may comprise sending a SIP re-INVITE message from the first terminal to the server.

The method may comprise, in the case where the whole session is being transferred, performing a procedure at the first terminal to leave the session.

The method may comprise sending a SIP BYE message from the first terminal to the server.

The part being transferred may comprise responsibility for at least one media type.

The method may comprise performing the method in response to receipt of an invitation to establish the session.

The invitation may comprise information identifying at least one media type not supported or accepted at the first terminal, and the method may comprise including the identifying information in the SIP REFER message.

The identifying information may comprise the SDP information.

The method may comprise performing the method to transfer at least part of an ongoing session.

The push to talk type session may be a session in a Push to talk over Cellular, PoC, service.

The push to talk type session may be a session in a conferencing service.

According to a second aspect of the present invention there is provided an apparatus comprising means for transferring at least part of a push to talk type session from a first terminal to a second terminal by using a Session Initiation Protocol, SIP, REFER message indicating which part, or that the whole, of the session is to be transferred.

The apparatus may comprise the first terminal.

According to a third aspect of the present invention there is provided an operating program which, when loaded into an apparatus, causes the apparatus to become an apparatus according to the second aspect of the present invention.

According to a fourth aspect of the present invention there is provided an operating program which, when run on an apparatus, causes the apparatus to carry out a method according to the first aspect of the present invention.

The operating program may be carried on a carrier medium. The carrier medium may be a transmission medium. The carrier medium may be a storage medium.

An embodiment of the present invention addresses one or more of the following technical issues:

(a) How the PoC Client indicates to the PoC Server performing the Controlling PoC Function that the PoC Session, or part thereof, is to be transferred;

(b) How the PoC Client should address the device to which the PoC Session is being transferred;

(c) How the PoC Client indicates the part of the PoC Session that is to be transferred; and

(d) How a PoC Client moves a non-supported media type to another PoC Client—since the media type is not supported, the PoC Client does not know how to set the appropriate parameters in the Session Description Protocol (SDP) [for details of SDP see IETF RFC 3550 ‘Session Description Protocol’http://www.ieft.org/rfc/rfc3261.txt].

### BRIEF DESCRIPTION OF THE DRAWINGS

FIG. 1 illustrates a signalling flow according to a first scenario in an embodiment of the present invention; and

FIG. 2 illustrates a signalling flow according to a second scenario in an embodiment of the present invention.

### DETAILED DESCRIPTION OF THE PREFERRED EMBODIMENTS

An embodiment of the present invention is based on procedures defined by OMA PoC (see: OMA PoC Requirement Document Version 1.0 OMA-RD-PoC-V1_{—}0; OMA PoC Control Plane Document Version 1.0 OMA-TS-PoC-Control Plane-V1_{—}0; OMA PoC User Plane Document Version 1.0 OMA-TS-PoC-User Plane-V1_{—}0; and OMA PoC XDM Specification Document Version 1.0 OMA-PoC_XDM_Specification-V1_{—}0, Open Mobile Alliance, http://www.openmobilealliance.org/), with some additions to achieve transfer of the session or part thereof.

As an example, consider the case where a user at a PoC Client wishes to transfer at least part of his/her PoC Session to another PoC Client on another device. The reason may be that the other device has more capabilities, e.g. a video capability. The transfer may only be one part, e.g. a video part or reception of pictures or video clip or a file. The decision to transfer the PoC Session may be a user decision or a PoC Client decision. For example, if the PoC Client receives a SIP INVITE request that wants to add a non-supported media type, the PoC Client can be configured to transfer that media part to another PoC Client using the received SDP parameters in a transfer procedure according to an embodiment of the present invention.

In an embodiment of the present invention, which will be described in more detail below, the PoC Client sends a SIP REFER message to the PoC Server. The SIP REFER message would typically include:

(a) The address of the PoC Client in the device to which the PoC Session is transferred. The address may be the PoC Address [OMA-TS-PoC-Control Plane-V1_{—}0], the GRUU [IETF draft-ietf-sip-gruu-05.txt “Obtaining and Using Globally Routable User Agent (UA) URIs (GRUU) in the Session Initiation Protocol (SIP), draft-ietf-sip-gruu-05, http://www.ietf.org/internet-drafts/draft-ietf-sip-gruu-05.txt], or any other routable address. Typically the PoC Client would use a PoC Address (e.g. a registered SIP URI or a telephone number in a TEL URI); and

(b) SDP [IETF RFC 3550] parameters to indicate which parts of the PoC Session that are being transferred (if only part of the PoC Session is being transferred);

In this embodiment, the PoC Client uses the procedure of RFC 3265, with the PoC Server sending notifications of the progress of the transfer. When the transfer is ready, the PoC Client receives a SIP NOTIFY request with the status-line 200 “OK” included, and the PoC Client can then either:

(1) Leave the PoC Session by means of a SIP BYE message, where the whole PoC Session has been transferred; or

(2) Re-negotiate the media parameters if required, where a part of the PoC Session has transferred and the PoC Client has previously indicated support for that part.

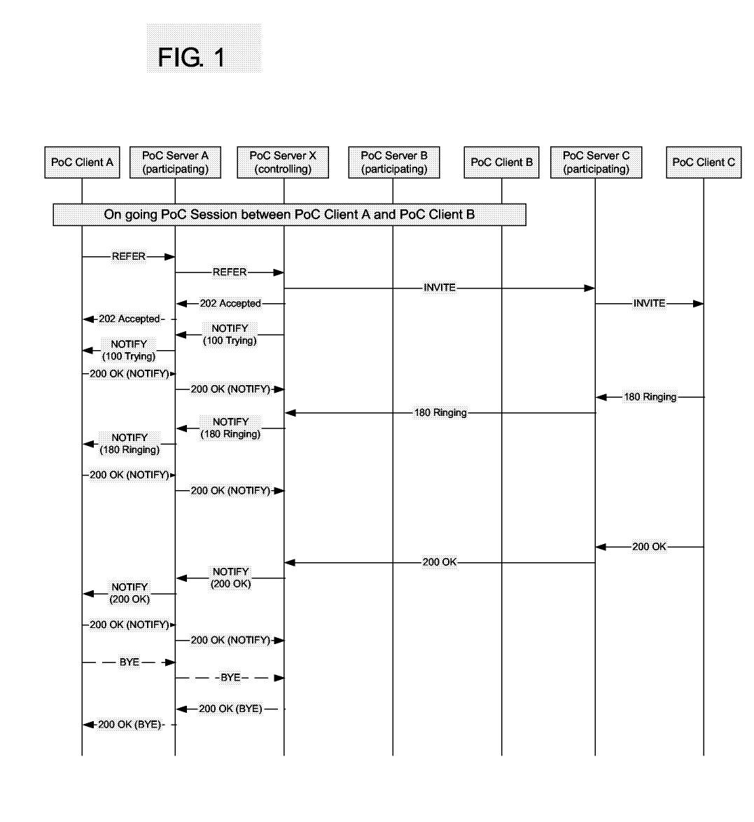

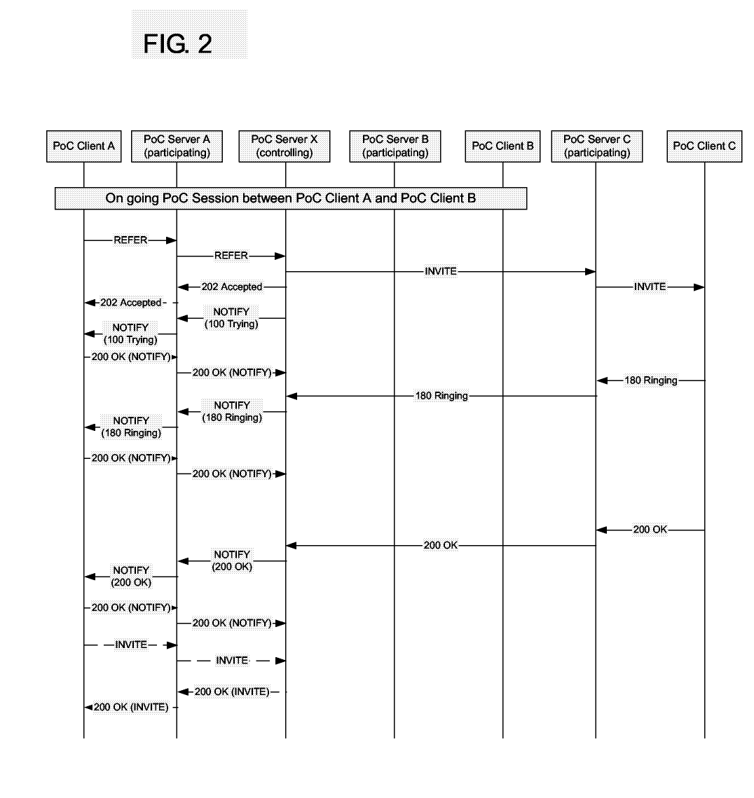

The operation of an embodiment of the present invention in the above two scenarios (1) and (2) will now be described separately with reference to (simplified) signalling flow illustrated in FIGS. 1 and 2 respectively.

Referring to FIG. 1, a PoC Session is ongoing between a PoC Client A and a PoC Client B. For some reason, the User at PoC Client A wishes to move to another PoC Client C. In the present scenario, PoC Client A wishes to transfer the whole PoC Session to PoC Client C.

PoC Client A sends a SIP REFER request as specified by the OMA PoC for adding a participant to a PoC Session. The SIP REFER request includes the PoC Address (e.g. a TEL URI) of PoC Client C. The SIP REFER message is sent to a PoC Server X performing the Controlling PoC Function, as specified in OMA PoC, via a PoC Server A performing the Participating PoC Function. The PoC Server X starts the procedure for inviting PoC Client C by means of the SIP INVITE message. The PoC Address of the PoC Client C is included in the SIP INVITE message.

It should be noted that the PoC Address of PoC Client C may be the same PoC Address as that for PoC Client A. If that is the case, PoC Client A will also receive the SIP INVITE request from PoC Server X, allowing PoC Client A to reject the invitation.

In this embodiment, the SIP REFER message does not include the option-tag “norefersub”, which means that the PoC Server X performing the Controlling PoC Function will report the status of the invitation procedure back to PoC Client A according to the OMA PoC procedure, for example sending the status 100 “Trying” or 180 “Ringing” in SIP NOTIFY messages as shown in FIG. 1 according to what, if anything, has been received back from PoC Client C in response to sending the SIP INVITE message.

When PoC Client C accepts the invitation, PoC Client C sends the SIP 200 OK response to the PoC Server X, and the PoC Server X in turn sends the SIP NOTIFY request with the status code 200 “OK” towards PoC Client A. When PoC Client A receives the status 200 “OK” in the SIP NOTIFY message, it knows that PoC Client C, to which the whole PoC Session is being moved, has accepted the invitation. This then allows the PoC Client A to leave the PoC Session, so that the PoC User can continue the PoC Session at PoC Client C. The PoC Client A leaves the PoC Session by means of the SIP BYE message.

Referring now to FIG. 2, a PoC Session is ongoing between a PoC Client A and a PoC Client B. For some reason, the User at PoC Client A wishes to move only the video part of the PoC Session to another PoC Client C.

PoC Client A sends a SIP REFER request as specified by the OMA PoC for adding a participant to a PoC Session. The SIP REFER request includes the PoC Address (e.g. a TEL URI) of PoC Client C and the SDP describing the part to be moved (for example, “transfer=video” would mean that PoC Client C is being requested to receive/send video). The SIP REFER message is sent to a PoC Server X performing the Controlling PoC Function, as specified in OMA PoC, via a PoC Server A performing the Participating PoC Function. The PoC Server X starts the procedure for inviting PoC Client C by means of the SIP INVITE message. The PoC Address of the PoC Client C and the SDP parameters are included in the SIP INVITE message. Note that the PoC Server X can remove or modify the SDP in order to align to the ongoing PoC Session.

It should be noted that the PoC Address of PoC Client C may be the same PoC Address as that for PoC Client A. If that is the case, PoC Client A will also receive the SIP INVITE request from PoC Server X, allowing PoC Client A to reject the invitation.

In this embodiment, the SIP REFER message does not include the option-tag “norefersub”, which means that the PoC Server X performing the Controlling PoC Function will report the status of the invitation procedure back to PoC Client A according to the OMA PoC procedure, for example sending the status 100 “Trying” or 180 “Ringing” in SIP NOTIFY messages as shown in FIG. 2 according to what, if anything, has been received back from PoC Client C in response to sending the SIP INVITE message.

When PoC Client C accepts the invitation, PoC Client C sends the SIP 200 OK response to the PoC Server X, and the PoC Server X in turn sends the SIP NOTIFY request with the status code 200 “OK” towards PoC Client A.

When PoC Client A receives the status 200 “OK” in the SIP NOTIFY message, it knows that PoC Client C, to which the video part of the PoC Session is being moved, has accepted the invitation. This then allows the PoC Client A to remove, if necessary, its support for video, so that the video part of the PoC Session can continue at PoC Client C (this is indicated to the user of PoC Client A). PoC Client A achieves this by sending a SIP re-INVITE message to PoC Server X via PoC Server A according to IETF RFC 3261.

Although an embodiment of the present invention is described above in relation to PoC, it will be appreciated that the invention is not limited to PoC. The term “push to talk” service is used here to identify services of a walkie-talkie nature. These are services that allow two or more users to be connected together quickly for the exchange of talk bursts. Push to Talk services differ from conventional voice calls in that these services allow only one person to talk at a given time. In order to talk, users must have control of the “floor”. Control is typically achieved by one user releasing a talk button to release floor control, and another user pressing a talk button to assume floor control. It is to be understood that the term “push to talk” used in the appended claims is not intended to imply the use of any particular protocol.

It is also to be understood that the scope of the present invention is not limited to the transfer of talk or speech data in a talk session, and the appended claims are to be read as covering the transfer of any type of data in a data transfer session, including but not limited to speech data. As such, terminology such as “Talk Burst Request” and “Talk Burst” is not to be interpreted as being limited to talk, i.e. speech, data only, but is used for consistency with PoC 1 terminology; such phrases can include within their meaning the transfer of any type of data. In PoC 2, different terminology may be used for concepts that correspond directly with those in PoC 1; for example the phrases “Media Burst Request” and “Media Burst” may be used instead.

It is also to be understood that the scope of the present invention is intended to include conferencing systems in which a participant is granted floor control and hence the right to speak or transfer data to other participants in the conference.

It will be appreciated that operation of one or more of the above-described components can be controlled by a program operating on the device or apparatus. Such an operating program can be stored on a computer-readable medium, or could, for example, be embodied in a signal such as a downloadable data signal provided from an Internet website. The appended claims are to be interpreted as covering an operating program by itself, or as a record on a carrier, or as a signal, or in any other form.

1-35. (canceled)

36. A method of transferring only a part of a push to talk type session from a first terminal to a second terminal, said method comprising the steps of:
creating in the first terminal, a Session Initiation Protocol (SIP) REFER message which identifies the second terminal and indicates which part of the session is to be transferred; and
sending the SIP REFER message from the first terminal to a server controlling the session.

37. The method as recited in claim 36, further comprising, before the creating step, the steps of:
receiving an invitation at the first terminal to establish the session, wherein the invitation includes information identifying a media type requested for the session; and
determining by the first terminal that the first terminal does not support the requested media type;
wherein the creating step includes identifying the non-supported requested media type in the SIP REFER message.

38. The method as recited in claim 36, wherein the method is performed to transfer part of an ongoing session.

39. The method as recited in claim 36, wherein the SIP REFER message includes an address of the second terminal.

40. The method as recited in claim 39, wherein the SIP REFER message includes a Push to talk over Cellular (PoC) address of the second terminal, said PoC address being selected from a SIP URI and a TEL URI.

41. The method as recited in claim 39, wherein the SIP REFER message includes a Globally Routable User Agent URI (GRUU) address of the second terminal.

42. The method as recited in claim 36, wherein the creating step includes indicating the part of the session to be transferred by including Session Description Protocol (SDP) information in the SIP REFER message.

43. The method as recited in claim 36, wherein the creating step also includes indicating a preference to receive update messages from the server by omitting a “norefersub” option-tag in the SIP REFER message.

44. The method as recited in claim 36, further comprising the steps of:
receiving a confirmation at the first terminal that responsibility for the transferred part of the session has been accepted by the second terminal; and
performing a procedure at the first terminal to remove responsibility for the transferred part of the session in response to receiving the confirmation.

45. The method as recited in claim 44, wherein the procedure to remove responsibility for the transferred part of the session includes sending a SIP re-INVITE message from the first terminal to the server.

46. The method as recited in claim 36, wherein the part of the session being transferred comprises responsibility for at least one media type.

47. The method as recited in claim 36, wherein the push to talk type session is a session in a Push to talk over Cellular (PoC) service.

48. The method as recited in claim 36, wherein the push to talk type session is a session in a conferencing service.

49. An apparatus in a first mobile terminal for transferring only a part of a push to talk type session from the first mobile terminal to a second mobile terminal, said apparatus comprising:
means for creating a Session Initiation Protocol (SIP) REFER message which identifies the second terminal and indicates which part of the session is to be transferred; and
means for sending the SIP REFER message from the first mobile terminal to a server controlling the session.

50. The apparatus as recited in claim 49, further comprising:
means for receiving an invitation to establish the session, wherein the invitation includes information identifying a media type requested for the session; and
means for determining that the first terminal does not support the requested media type;
wherein the creating means identifies the non-supported requested media type in the SIP REFER message.

51. The apparatus as recited in claim 49, further comprising:
means for receiving a confirmation that responsibility for the transferred part of the session has been accepted by the second terminal; and
means for performing a procedure to remove responsibility for the transferred part of the session in response to receiving the confirmation.

52. A method of transferring only a part of a push to talk type session from a first terminal to a second terminal, said method comprising the steps of:
receiving by a server controlling the session, a Session Initiation Protocol (SIP) REFER message from the first terminal, said SIP REFER message identifying the second terminal and indicating which part of the session is to be transferred; and
sending a SIP INVITE message to the second terminal indicating which part of the session is to be transferred.

53. The method as recited in claim 52, wherein the SIP REFER message includes Session Description Protocol (SDP) information to indicate the part of the session to be transferred, and the method further comprises, when the session is ongoing, the step of removing or modifying the SDP information at the server in order to align with the ongoing session.

54. The method as recited in claim 52, wherein the SIP REFER message includes Session Description Protocol (SDP) information to indicate the part of the session to be transferred, and the step of sending a SIP INVITE message includes sending the SIP INVITE message with the SDP information included therein.

55. The method as recited in claim 52, further comprising sending at least one status update message to the first terminal to inform the first terminal of progress of the transfer.

56. The method as recited in claim 55, wherein at least one status update message is a SIP NOTIFY message selected from a “Ringing” and a “Trying” message.

57. An apparatus in a server for transferring only a part of a push to talk type session from a first terminal to a second terminal, said apparatus comprising:
means for receiving a Session Initiation Protocol (SIP) REFER message from the first terminal, said SIP REFER message identifying the second terminal and indicating which part of the session is to be transferred; and
means for sending a SIP INVITE message to the second terminal indicating which part of the session is to be transferred.

58. The apparatus as recited in claim 57, wherein the SIP REFER message includes Session Description Protocol (SDP) information to indicate the part of the session to be transferred, and the apparatus further comprises means for removing or modifying the SDP information in order to align with an ongoing session.

59. The apparatus as recited in claim 57, wherein the SIP REFER message includes Session Description Protocol (SDP) information to indicate the part of the session to be transferred, and the means for sending a SIP INVITE message includes means for sending the SIP INVITE message with the SDP information included therein.

60. The apparatus as recited in claim 57, further comprising means for sending at least one status update message to the first terminal to inform the first terminal of progress of the transfer.

61. The apparatus as recited in claim 60, wherein at least one status update message is a SIP NOTIFY message selected from a “Ringing” and a “Trying” message.
